(19) United States
(12) Patent Application Publication
(10) Pub. No.: US 2021/0021156 A1
(43) Pub. Date: Jan. 21, 2021

(54) TRUE OPTIMIZABLE WIRELESS POWER SYSTEMS

(71) Applicant: ChargEdge, Inc., Fremont, CA (US)

(72) Inventor: Sanjaya Maniktala, Fremont, CA (US)

(21) Appl. No.: 16/929,607

(22) Filed: Jul. 15, 2020

Related U.S. Application Data
(60) Provisional application No. 62/873,985, filed on Jul. 15, 2019.

(51) Int. Cl. H02J 50/12; H02J 50/40

(52) U.S. Cl. CPC H02J 50/12; H02J 50/402

(57) ABSTRACT

A wireless power transfer system comprising a wireless power transmitter comprising a transmitter coil configured to receive a time-varying current that flows in the transmitter coil to produce a transmitter magnetic field. The wireless power transfer system also comprises a wireless power receiver comprising a receiver coil, and a resonant capacitor. The transmitter magnetic field is configured to couple the wireless power transmitter with the wireless power receiver to induce a time-varying current to flow in the receiver coil of the wireless power receiver. Additionally, the resonant capacitor is only coupled to either the wireless power transmitter or the wireless power receiver, but not both.

### CROSS REFERENCE APPLICATION

This application claims priority to and the benefit of U.S. Provisional Patent Application No. 62/873,985, filed on Jul. 15, 2019, entitled “TRUE OPTIMIZABLE WIRELESS POWER SYSTEMS”, the subject matter of which is hereby incorporated by reference in its entirety.

### FIELD

The present invention generally relates to systems for optimizing wireless power transfer utilizing a single tuned resonator circuit.

### BACKGROUND

Wireless power transfer (WPT) involves the use of time-varying magnetic fields to wireles sly transfer power from a source to a device. Faraday's law of magnetic induction provides that if a time-varying current is applied to one coil (e.g., a transmitter coil) a voltage will be induced in a nearby second coil (e.g., a receiver coil). The voltage induced in the receiver coil can then be rectified and filtered to generate a stable DC voltage for powering an electronic device or charging a battery. The receiver coil and associated circuitry for generating a DC voltage can be connected to or included within the electronic device itself such as a smartphone or other portable device.

The Wireless Power Consortium (WPC) was established in 2008 to develop the Qi inductive power standard for charging and powering electronic devices. Powermat is another well-known standard for WPT developed by the Power Matters Alliance (PMA). There also have been some market consolidation efforts to unite into larger organizations, such as the AirFuel Alliance consisting of PMA and the Rezence standard from the Alliance For Wireless Power (A4WP).

Earlier versions of both the Qi and Powermat standards fixed the peak resonant frequency of the wireless power transfer process at 100 kHz for Qi and 277 kHz for Powermat. These fixed values are based on the nominal values of the primary inductance of the transmitter coil and the primary capacitance of the associated transmitter-side resonant capacitor in series with the transmitter coil. The operating frequency for transmitters called for in these standards is based on these assumed fixed resonant frequencies. In actual wireless power transmitters the peak resonant frequency is not fixed but is rather a function of the nominal inductance and capacitance values of the transmitter coil and capacitor and other factors such as component variations, load, and leakage. Different wireless power receivers may put different loads on a particular wireless power transmitter, and power leakage varies depending on how well-aligned a wireless power receiver's coil is to the transmitter coil. The entire behavior of the wireless power transfer system is affected by variations in the actual resonant frequency of a wireless power transmitter.

Later versions of these standards allow for slight variations in the operating frequency away from the assumed fixed resonant frequency, but these variations still rely on the basic assumption that the resonant frequency of the transmitter is a known, fixed value based on the nominal inductance of the transmitter coil (measured without being magnetically coupled to a receiver coil) and the nominal capacitance of the resonant capacitor. The Qi standard still requires that the receiver is tuned to a fixed frequency, the fixed frequency being tuned to the assumed fixed resonant frequency of the transmitter, i.e., 100 KHz. The assumed resonant frequency is determined from the measurement of the receiver coil inductance without being in proximity to a transmitter coil and the receiver resonant capacitor. In actual operating Qi systems, while the transmitter and receiver are magnetically coupled, variable resonant frequencies are generated, which is not just unpredictable but adversely affects the ability to deliver more power.

As maximum power transfer in a wireless power system occurs when the operating frequency is close to or at the resonant frequency, an incorrect assumption about the resonant frequency affects the ability of the system to deliver close to maximum power. The incorrect assumption about the resonant frequency also creates anomalies in the control loop. For example, in the Qi and PowerMat systems, when the receiver requests an increase in power, the Qi and Powermat systems lower the operating frequency of the transmitter to be closer to the assumed fixed resonant frequency. As the actual (and varying) resonant frequency was often higher than the assumed resonant frequency, the delivered power would decrease instead and the transmitter would turn off due to this anomaly, sometimes referred to as “control inversion.” For example, if the actual resonant frequency of a wireless power transfer system is 150 kHz but the assumed resonant frequency is 100 kHz, the system may adjust the operating frequency closer to 100 kHz in an attempt to increase the delivered power but may actually be lowering the delivered power by moving too far away from the actual resonant frequency. An operating frequency that is too far from the actual resonant frequency can also cause large unanticipated voltage peaks in the resonant components in both the receiver and the transmitter. The reliability of the wireless power transfer system thus can also be affected by assuming an incorrect fixed resonant frequency.

Thus, there is a long felt need for a wireless power transfer system in which the variability of system performance at resonance is clearly understood so as to optimized the system performance for maximum power transfer.

### SUMMARY

According to an embodiment of the present disclosure there is provided a wireless power transfer system comprising a wireless power receiver comprising a receiver coil configured to couple with a magnetic field emitted by a wireless power transmitter, wherein a time-varying current is induced in the receiver coil by the magnetic field, and the wireless power receiver does not comprise a resonant capacitor.

In some implementations, a frequency response of the wireless power transfer system comprises a single significant peak. In other implementations, the receiver coil comprises any combination of single spiral coils, multiple spiral coils, longitudinal coils, or coils having any polarity structure. In certain implementations, the wireless power receiver may further comprise at least one auxiliary non-resonant capacitor. In further implementations, the auxiliary capacitor does not does not contribute to or affect an existing resonant frequency of the wireless power transfer system. In some implementations, the auxiliary capacitor does not create another peak in the frequency response of the wireless power system. In other implementations, the auxiliary capacitor is greater than about 470 nF. In certain implementations, a single significant resonant frequency of the system is configured to be less than about 400 kHz.

According to another embodiment of the present disclosure there is provided a wireless power transfer system comprising a wireless power transmitter comprising a transmitter coil configured to receive a time-varying current that flows in the transmitter coil to produce a transmitter magnetic field. The wireless power transfer system also comprises wireless power receiver comprising a receiver coil, and a resonant capacitor. In the wireless power transfer system, the transmitter magnetic field is configured to couple the wireless power transmitter with the wireless power receiver to induce a time-varying current to flow in the receiver coil of the wireless power receiver. In addition, the resonant capacitor in the wireless power transfer system is coupled to the wireless power transmitter and not the wireless power receiver.

In certain implementations, the resonant capacitor is configured to set a resonant frequency of the wireless power transmitter when the wireless power receiver is unloaded. In some implementations, the resonant capacitor is physically located in the wireless power transmitter and not the wireless power receiver. In other implementations, a frequency response of the wireless power transfer system comprises a single significant peak. In other implementations, the wireless power transmitter and/or the wireless power receiver may further comprise at least one auxiliary non-resonant capacitor. In further implementations, the auxiliary capacitor does not contribute to or affect an existing resonant frequency of the wireless power transfer system. In some implementations, the auxiliary capacitor does not create another peak in the frequency response of the wireless power system. In certain implementations, the auxiliary capacitor is greater than 470 nF. In other implementations, the transmitter and receiver coils comprise any combination of single spiral coils, multiple spiral coils, longitudinal coils, or coils having any polarity structure. In some implementations, a single significant resonant frequency of the system is configured to be less than about 400 kHz.

According to another embodiment of the present disclosure there is provided a wireless power transfer system comprising a wireless power transmitter comprising a transmitter coil configured to receive a time-varying current that flows in the transmitter coil to produce a transmitter magnetic field. The wireless power transfer system also comprises a wireless power receiver comprising a receiver coil, and a resonant capacitor. In the wireless power transfer system, the transmitter magnetic field is configured to couple the wireless power transmitter with the wireless power receiver to induce a time-varying current to flow in the receiver coil of the wireless power receiver. In addition, the resonant capacitor is only coupled to either the wireless power transmitter or the wireless power receiver, but not both.

In some implementations, the resonant capacitor is only coupled to the wireless power transmitter and not the wireless power receiver. In other implementations, the resonant capacitor is only coupled to the wireless power receiver and not the wireless power transmitter. In further implementations, the resonant capacitor is configured to set a resonant frequency of the wireless power transmitter when the resonant capacitor is only coupled to the wireless power transmitter and the wireless power receiver is unloaded. In certain implementations, the resonant capacitor is configured to set a resonant frequency of the wireless power receiver when the resonant capacitor is only coupled to the wireless power receiver and the wireless power receiver is unloaded.

In other implementations, the resonant capacitor is physically located in the wireless power transmitter and not the wireless power receiver. In further implementations, the resonant capacitor is physically located in the wireless power receiver and not the wireless power transmitter. In some implementations, a frequency response of the wireless power transfer system comprises a single significant peak. In certain implementations, the wireless power transmitter and/or the wireless power receiver may further comprise at least one auxiliary non-resonant capacitor. In other implementations, the auxiliary capacitor does not contribute to or affect an existing resonant frequency of the wireless power transfer system. In further implementations, the auxiliary capacitor does not create another peak in the frequency response of the wireless power system. In some implementations, the auxiliary capacitor is greater than 470 nF.

In some implementations, the transmitter and receiver coils comprise any combination of single spiral coils, multiple spiral coils, longitudinal coils, or coils having any polarity structure. In certain implementations, a resonant frequency of the system is configured to be less than about 400 kHz. In other implementations, a resonant frequency of the system is configured to be between about 80 kHz and 100 kHz. In further implementations, a resonant frequency of the system is configured to be about 85 kHz.

### BRIEF DESCRIPTION OF DRAWINGS

The foregoing and other objects and advantages will be apparent upon consideration of the following detailed description, taken in conjunction with the accompanying drawings, in which like reference characters refer to like parts throughout, and in which:

FIG. 1A illustrates an equivalent circuit diagram of a wireless power transfer system;

FIG. 1B illustrates an equivalent circuit diagram of a wireless power transfer system without a resonant capacitor in the receiver circuit, according to one or more embodiments of the present disclosure;

FIG. 1C illustrates a an equivalent circuit diagram of a wireless power transfer system without a resonant capacitor in the transmitter circuit, according to one or more embodiments of the present disclosure;

FIG. 2A illustrates a circuit diagram of the wireless power transfer system of FIG. 1B, according to one or more embodiments of the present disclosure;

FIG. 2B illustrates a circuit diagram of the wireless power transfer system of FIG. 1C, according to one or more embodiments of the present disclosure;

FIG. 3A illustrates a circuit diagram of the wireless power transfer system of FIG. 1A, implemented with a single coil, a single resonant capacitor and a half-bridge rectifier in the transmitter circuit;

FIG. 3B illustrates a circuit diagram of the wireless power transfer system of FIG. 1B implemented with a single coil, a single resonant capacitor and a half-bridge rectifier in the transmitter circuit, according to one or more embodiments of the present disclosure;

FIG. 3C illustrates a circuit diagram of the wireless power transfer system of FIG. 1A implemented with a single coil, double resonant capacitors and a full bridge rectifier in the transmitter circuit;

FIG. 3D illustrates a circuit diagram of the wireless power transfer system of FIG. 1B implemented with a single coil, double resonant capacitors and a full bridge rectifier in the transmitter circuit, according to one or more embodiments of the present disclosure;

FIG. 4A illustrates a circuit diagram of the wireless power transfer system of FIG. 1A implemented with a single coil, a single resonant capacitor and a full bridge rectifier in the transmitter circuit;

FIG. 4B illustrates a circuit diagram of the wireless power transfer system of FIG. 1B implemented with a single coil, a single resonant capacitor and a full bridge rectifier in the transmitter circuit, according to one or more embodiments of the present disclosure;

FIG. 5A illustrates a circuit diagram of the wireless power transfer system of FIG. 1A implemented with a double coil, a single resonant capacitor and a full bridge rectifier in the transmitter circuit;

FIG. 5B illustrates a circuit diagram of the wireless power transfer system of FIG. 1B implemented with a double coil, a single resonant capacitor and a full bridge rectifier in the transmitter circuit, according to one or more embodiments of the present disclosure;

FIG. 6A illustrates a circuit diagram of the wireless power transfer system of FIG. 1A implemented with a double coil, double resonant capacitors and a full bridge rectifier in the transmitter circuit; and

FIG. 6B illustrates a circuit diagram of the wireless power transfer system of FIG. 1B implemented with a double coil, double resonant capacitors and a full bridge rectifier in the transmitter circuit, according to one or more embodiments of the present disclosure.

### DETAILED DESCRIPTION

To provide an overall understanding of the devices described herein, certain illustrative embodiments will be described. Although the embodiments and features described herein are specifically described for use in wireless power transfer systems, it will be understood that all the components and other features outlined below may be combined with one another in any suitable manner and may be adapted and applied to other types power transfer systems desiring optimized power transfer to a receiver circuit coupled to a load.

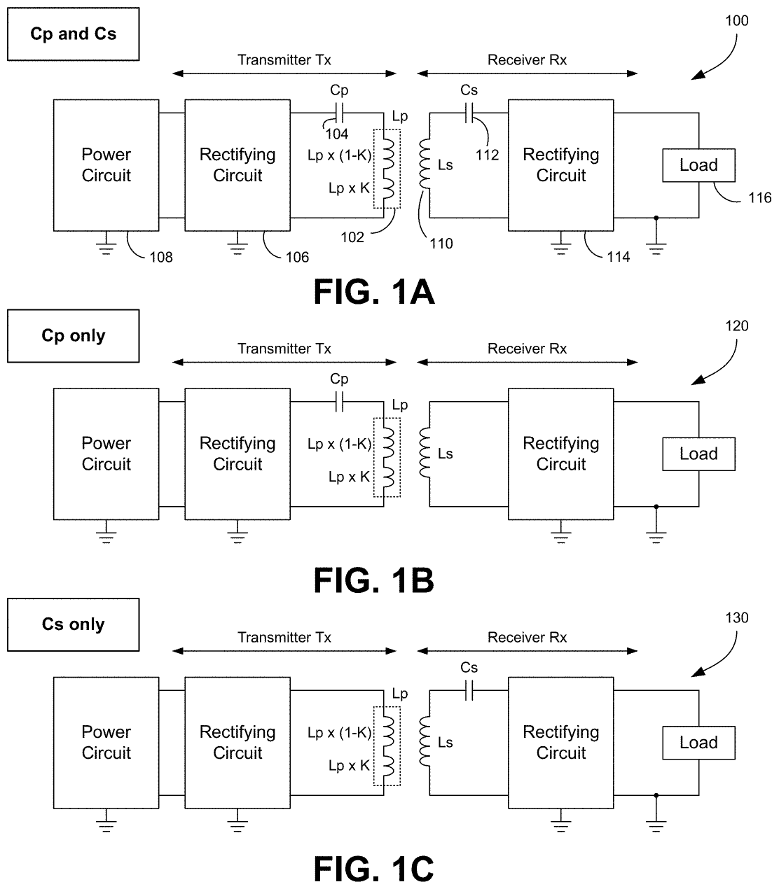

FIG. 1A is a block diagram illustrating a wireless power transfer system 100. The wireless power transfer system 100 comprises a transmitter circuit Tx and a receiver circuit Rx. The transmitter circuit Tx comprises a primary coil 102 having an inductance Lp, and is connected to primary capacitor 104 having a capacitance Cp. While the primary coil 102 and the primary capacitor 104 are shown as being connected in series, they may be connected in parallel. The primary coil 102 and the primary capacitor 104 are connected to a rectifying circuit 106. The rectifying circuit 106 may comprise a bridge rectifier, such as a half bridge rectifier or a full bridge rectifier, for example, as are known in the art. The transmitter circuit Tx is supplied with current and voltage from a power circuit 108. The receiver circuit Rx comprises a secondary coil 110 having an inductance Ls, and is connected to secondary capacitor 112 having a capacitance Cs. While the secondary coil 110 and the secondary capacitor 112 are shown as being connected in series, they may be connected in parallel. The secondary coil 110 and the secondary capacitor 112 are connected to a rectifying circuit 114. The rectifying circuit 114 may comprise a bridge rectifier, such as a half bridge rectifier or a full bridge rectifier, for example. The output from the rectifying circuit 114 is supplied to a load 116.

Coils 102 and 110 may be magnetically coupled together by placing both coils in close proximity to each other and/or by placing both coils 102, 110 on a magnetic layer. The magnetic layer can be ferrite or any other magnetic layer known in the art. Coils 102 and 110 may comprise coils of any topology, such as, for example, single spirals, double spirals, longitudinal coils, etc. Coils 102 and 110 are preferably identical coils with the same number of turns, the same area, and wound in the same direction (i.e., clockwise or counter-clockwise). The power circuit 108 generates an AC signal of a defined voltage magnitude. The generated AC signal can be, but is not limited to, a square wave, a sinusoidal wave, a triangular wave, or a sawtooth wave. The AC signal causes time-varying current to flow from power circuit 108 through the rectifying circuit 106 to primary coil 102. The flow of current through coil 102 of the transmitter circuit Tx generates a magnetic field.

The magnetic field magnetically couples to the secondary coil 110 and induces a time-varying current that flows through the secondary coil 110 to the secondary capacitor 112 and the rectifying circuit 114. Faraday's law provides that the time-varying current that flows in the secondary coil 110 will oppose the magnetic field generated by the primary coil 102. The voltage generated as a result of the coupling of the primary coil 102 with the secondary coil 110 with the generated magnetic field is provided to the load 116, which may be a rechargeable battery or power a device (e.g., a smart phone, laptop or any other electronic device).

The wireless power transfer system 100 in FIG. 1A may be left open to tune the open (unloaded) primary coil 102 inductance Lp with its series or parallel primary capacitance Cp to a certain frequency. For example the Qi standard tunes it to about 100 kHz, and for applications such as in modern electric vehicles, Lp is tuned to between about 80 kHz to about 100 kHz (about 85 kHz is recommended by the Society of Automotive Engineers (SAE), referred to as J2594, see https://www.sae.org/standards/content/j2954/). The wireless power transfer system 100 then tunes the secondary coil 110 (when no load is attached, i.e. open inductance) with the series or parallel secondary capacitance Cs to exactly the same frequency as Cp, i.e. about 100 kHz for the Qi standard, for example, and about 85 kHz for charging of electric vehicles.

Such tuning between a primary coil of a transmitter and a secondary coil of a receiver is known in the art and is likened to the analogy of tuning forks in sympathetic resonance, or opera singers supposedly breaking wine glasses by matching the transmitter frequency to a receiver frequency. This frequency tuning or matching shall be referred to as a “double resonator” approach and is based on the transformer model. A more detailed and accurate understanding of the transformer model is explained in U.S. patent application Ser. No. 16/287,660, filed on Feb. 27, 2019, and entitled “SYSTEMS AND METHODS FOR HIGH-POWER WIRELESS POWER TRANSFER WITH DUAL-QI COMPATABILITY,” the contents of which are hereby incorporated by reference in its entirety. However neither the Qi standards body nor the SAE recognized the significant effect to the resonant profile during operation, which the present disclosure seeks to document and adapt to. The “double resonator” approach is invalid in a closely coupled system as there is a significant shift of the resonant peak in the frequency response of the system as a result of reflected impedances in the closed system.

Nonetheless, the wireless power transfer system as shown in FIG. 1A is not a simple LCR circuit with an almost constant frequency response. Rather, such wireless power transfer system is better approximated as an LLCR circuit having two peaks in its frequency response, the second peak being dependent on the leakage component of the primary coil 102 having inductance Lp. Thus the inductance Lp of the primary coil 102 should actually be split into a coupled portion Lp×K and an uncoupled (leakage) portion Lp×(1−K), where K is the coupling coefficient between the coils 102, 110. This gives rise to the two resonant peaks in the frequency response of the wireless power transfer circuit of FIG. 1A. With no load on the receiver, the frequency response of the circuit shown in FIG. 1A shows a first peak at a resonant frequency based on Lp×K and Cp, and with a high load on the receiver the frequency response of the circuit shown in FIG. 1A shows a second peak at a resonant frequency based on the leakage component Lp×(1−K) and Cp. Hence the circuit shown in FIG. 1A is best approximated as an LLCR circuit, and not a simple LCR as has been assumed in the art.

In the circuit of FIG. 1A, the receiver Rx also comprises a secondary capacitor 112 with a capacitance Cs. As mentioned above, the secondary capacitor 112 is present to tune the receiver Rx to the same frequency as the transmitter Tx. However the secondary capacitance Cs complicates the system as the circuit shown in FIG. 1A now becomes an LLCCR circuit with two resonant capacitors, i.e. the primary capacitor 104 with capacitance Cp and the secondary capacitor 112 with capacitance Cs. The presence of two resonant capacitors, one on the transmitter side and one on the receiver side, produce not one, but two simultaneous resonant peaks, moving very significantly as a function of load applied to the receiver, and as a function of the coupling between the transmitter and receiver coils. The two resonant peaks keep moving in a very unpredictable manner as loading and coupling in the system 100 changes. Any prospect of tracking the resonant peaks is futile as no tracking algorithm can keep up with multiple moving resonant peaks. It is therefore an objective of the present disclosure to optimize the performance of wireless power systems by relying on the LLCR circuit.

The present disclosure therefore only has one resonant capacitor present in a wireless power transfer system, as shown in FIGS. 1B and 1C according to one or more embodiments of the present disclosure. The circuits 120 and 130 in FIGS. 1B and 1C contain elements that are similar to those in circuit 100 shown in FIG. 1A, and so the description of such similar elements would not be repeated here for the sake of brevity. Notwithstanding, according to an embodiment of the present disclosure, the wireless power system 120 as shown in FIG. 1B has a transmitter Tx comprising a primary coil 102 having an inductance Lp connected to a primary capacitor 104 having a capacitance Cp, and a receiver Rx comprising a secondary coil 110 having an inductance Ls only. The wireless power system 120 does not have a secondary capacitor Cs. In some implementations, the receiver Rx may have other auxiliary capacitors present, such as within the rectifying circuit 114 or coupled in parallel to the load 116, however these auxiliary capacitors are very large (e.g. greater than about 470 nF) and do not affect the resonant frequency of the transmitter or the resonant frequency of the system as a whole when the receiver circuit Rx is unloaded.

Similarly, according to an embodiment of the present disclosure, the wireless power system 130 as shown in FIG. 1C has a transmitter Tx comprising a primary coil 102 having an inductance Lp only, and a receiver Rx comprising a secondary coil 110 having an inductance Ls, and a secondary capacitor 112 having a capacitance Cs. The wireless power system 130 does not have a primary capacitor Cp. In some implementations, the transmitter Tx may have other auxiliary capacitors present, such as within the rectifying circuit 106 or coupled in parallel to the power circuit 108, however these auxiliary capacitors are very large (e.g. greater than about 470 nF) and do not affect the resonant frequency of the transmitter or the resonant frequency of the system as a whole when the receiver circuit Rx is unloaded.

In wireless power system 120 shown in FIG. 1B and wireless power system 130 shown in FIG. 1C, there is only one resonant tuned circuit and not two (or more) resonant tuned circuits as shown in the wireless power system 100 shown in FIG. 1A. In the wireless power system 120 shown in FIG. 1B, only Cp is present and not Cs. In the wireless power system 130 shown in FIG. 1C, only Cs is present and not Cp. In both of the embodiments shown in FIGS. 1B and 1C, each of the systems 120 and 130 work as LLCR circuits which gives a predictable frequency response with a single significant peak and without any moving double peaks as seen when using the “double resonator” approach. The embodiments of the present disclosure are not trying to tune both the transmitter Tx and the receiver Rx to a same frequency, as is done in the art. Rather, according to embodiments of the present disclosure, only the transmitter Tx or the receiver Rx have a tuned LC circuit.

The wireless power systems 120 and 130 may comprise at least one auxiliary capacitor that does not contribute to, or affect an existing resonant frequency of the wireless power transfer system. Additionally, the at least one auxiliary capacitor does not create another significant or noticeable resonant peak in the frequency response of the system. In some implementations, the auxiliary capacitor is at least 470 nF. This ensures that the auxiliary capacitor does not create another significant or noticeable resonant peak in the frequency response of the system. In general, the contribution of the auxiliary capacitor in the wireless power system to the frequency response of the wireless power system is considered to be insignificant if the resonant frequency of the open-circuit receiver with the auxiliary capacitor connected is three times lower than the resonant frequency of the open-circuit transmitter. Here the open-circuit receiver refers to the non-operating inductance of the receiver coil combined with the remaining receiver circuit elements (e.g. the auxiliary capacitor and the secondary capacitor), with the transmitter coil in its vicinity or not. Similarly, the open-circuit transmitter refers to the non-operating inductance of the transmitter coil combined with the remaining transmitter circuit elements (e.g. the primary capacitor), with the receiver coil in its vicinity or not.

It should be noted that the embodiments of the present disclosure as shown in FIGS. 1B and 1C can be implemented using any type of coils and any type of topology for driving the circuits. For example the transmitter and receiver coils 102, 110 could be any combination of single, or multiple spiral coils, or longitudinal coils, or coils having any polarity structure. Additionally, the transmitter Tx and receiver Rx drive circuits could be any one of Class A, Class B, Class AB, Class C, Class D, Class E, Class T. Further, the in the embodiments shown in FIGS. 1B and 1C of present disclosure, the rectifying circuits 108, 114 can be any one of a half-bridge or a full-bridge rectifier.

Exemplary topologies for transmitter and receiver coils of the present disclosure, and associated drive circuitry, are described in the following patents and/or patent applications, the contents of which are hereby incorporated by reference in entirety: U.S. patent application Ser. No. 15/028,725 (now U.S. Pat. No. 10,581,276), filed on Mar. 28, 2016, and entitled “TUNED RESONANT MICROCELL-BASED ARRAY FOR WIRELESS POWER TRANSFER”; U.S. patent application Ser. No. 15/082,533 (now U.S. Pat. No. 10,374,459), filed on Mar. 28, 2016 and U.S. patent application Ser. No. 16/532,168, filed on Aug. 5, 2019, both entitled “WIRELESS POWER TRANSFER USING MULTIPLE COIL ARRAYS”; U.S. patent application Ser. No. 15/082,672 (now U.S. Pat. No. 10,263,471), filed on Mar. 28, 2016, and U.S. patent application Ser. No. 16/384,555, filed on Apr. 15, 2019, both entitled “MULTIPLE INTERLEAVED COIL STRUCTURES FOR WIRELESS POWER TRANSFER”; U.S. patent application Ser. No. 15/448,196, filed on Mar. 2, 2017, and entitled “RECEIVER COIL ARRANGEMENTS FOR INDUCTIVE WIRELESS POWER TRANSFER FOR PORTABLE DEVICES”; U.S. patent application Ser. No. 15/635,495 (now U.S. Pat. No. 10,312,745), filed on Jun. 28, 2017, and entitled “WIRELESS POWER TRANSFER SYSTEM WITH AUTOMATIC FOREIGN OBJECT REJECTION”; U.S. patent application Ser. No. 15/693,201, filed on Aug. 31, 2017, and entitled “SEGMENTED AND LONGITUDINAL RECEIVER COIL ARRANGEMENTS FOR WIRELESS POWER TRANSFER”; U.S. patent application Ser. No. 15/708,426, filed on Sep. 19, 2017, and entitled “BENT COIL STRUCTURE FOR WIRELESS POWER TRANSFER”; U.S. patent application Ser. No. 15/375,499, filed on Dec. 12, 2016, and entitled “SYSTEM FOR INDUCTIVE WIRELESS POWER TRANSFER FOR PORTABLE DEVICES”; U.S. patent application Ser. No. 15/613,538, filed on Jun. 5, 2017, and entitled “COIL STRUCTURES FOR ALIGNMENT AND INDUCTIVE WIRELESS POWER TRANSFER”, U.S. patent application Ser. No. 15/866,786 (now allowed), filed on Jan. 10, 2018, and entitled “WHEEL COILS AND CENTER-TAPPED LONGITUDINAL COILS FOR WIRELESS POWER TRANSFER”; U.S. patent application Ser. No. 15/882,147, filed on Jan. 29, 2018, and entitled “SYSTEM AND METHOD FOR FREQUENCY CONTROL AND FOREIGN OBJECT DETECTION IN WIRELESS POWER TRANSFER”; and U.S. patent application Ser. No. 16/287,660, filed on Feb. 27, 2019, and entitled “SYSTEMS AND METHODS FOR HIGH-POWER WIRELESS POWER TRANSFER WITH DUAL-QI COMPATABILITY.”

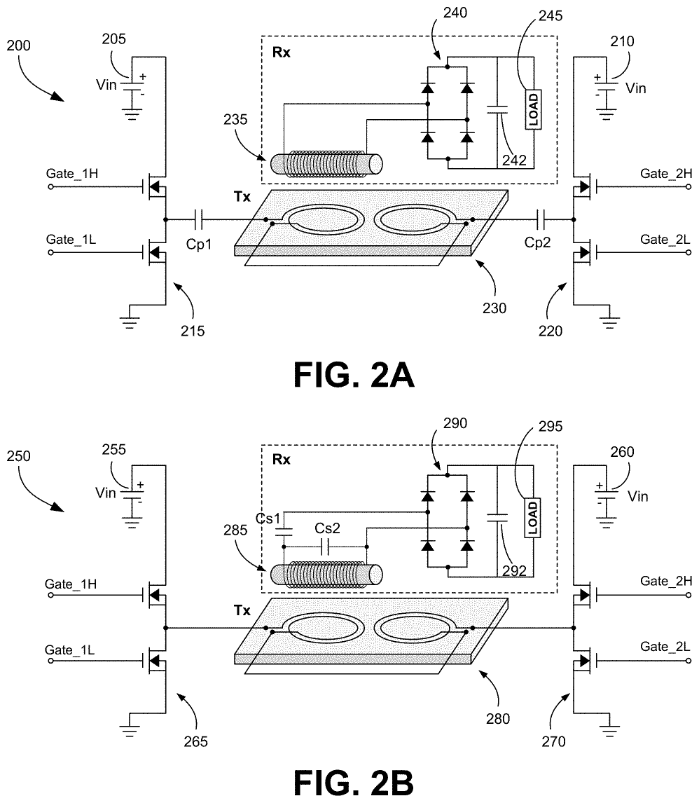

FIG. 2A illustrates an implementation of the embodiment illustrated in FIGS. 1B without a secondary resonant capacitor Cs, according to an implementation of the present disclosure. The wireless power transfer system 200 in FIG. 2A comprises a transmitter circuit Tx and a receiver circuit Rx. The transmitter circuit Tx comprises a primary coil 230 having an inductance Lp, and connected to primary capacitors having a capacitances Cp1 and Cp2. The primary coil 230 is shown bonded to a sheet made from a ferromagnetic material to enhance the magnetic field generated by the coil 230. While the primary coil 230 and the primary capacitors are shown as being connected in series, they may be connected in parallel. The primary coil 230 and the primary capacitors are connected to half-bridge rectifying circuits 215, 220. The transmitter circuit Tx is supplied with current and voltage from power circuits 205, 210. The receiver circuit Rx comprises a secondary coil 235 having an inductance Ls. While the secondary coil 235 is shown as a coil wound around a magnetic core, any coil structure or topology may be used. Wireless power transfer system 200 does not comprise a secondary capacitor Cs. The secondary coil 235 is connected to a full bridge rectifying circuit 240. An auxiliary capacitor 242 is connected in parallel with the full bridge rectifier 240. Auxiliary capacitor 242 does not affect the resonant frequency of the transmitter Tx, or the resonant frequency of the system 200 as a whole. The output from the rectifying circuit 240 is supplied to a load 245.

FIG. 2B illustrates an implementation of the embodiment illustrated in FIGS. 1C without a primary resonant capacitor Cp, according to an implementation of the present disclosure. The wireless power transfer system 250 in FIG. 2B comprises a transmitter circuit Tx and a receiver circuit Rx. The transmitter circuit Tx comprises a primary coil 280 having an inductance Lp. The primary coil 280 is shown bonded to a sheet made from a ferromagnetic material to enhance the magnetic field generated by the coil 280. Wireless power transfer system 250 does not comprise a primary capacitor Cp. The primary coil 280 is directly connected to half-bridge rectifying circuits 265, 270. The transmitter circuit Tx is supplied with current and voltage from power circuits 255, 260. The receiver circuit Rx comprises a secondary coil 285 having an inductance Ls connected in series with a secondary capacitor Cs1, and in parallel with a secondary capacitor Cs2. While the secondary coil 285 is shown as a coil wound around a magnetic core, any coil structure or topology may be used. The secondary coil 285 is connected to a full bridge rectifying circuit 290. An auxiliary capacitor 292 is connected in parallel with the full bridge rectifier 290. Auxiliary capacitor 292 does not affect the resonant frequency of the transmitter Tx, or the resonant frequency of the system 250 as a whole. The output from the rectifying circuit 290 is supplied to a load 295.

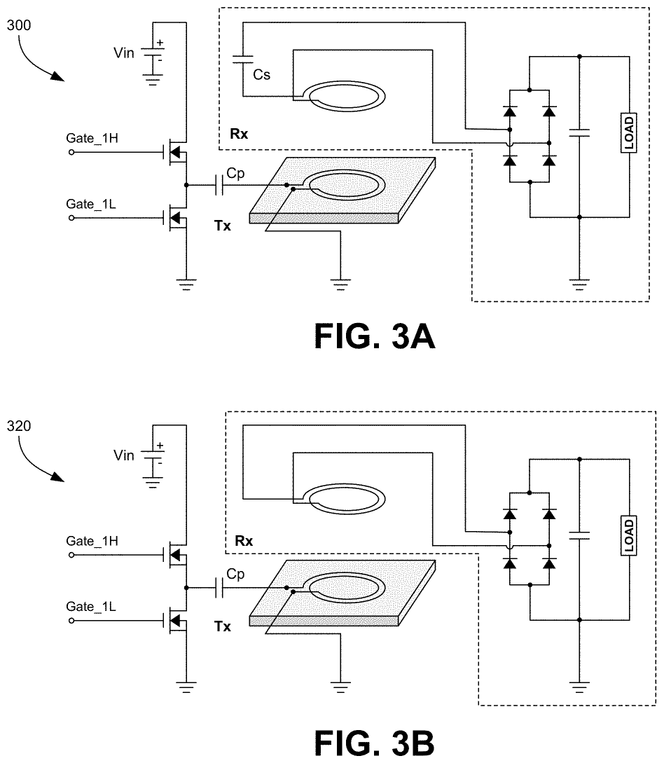

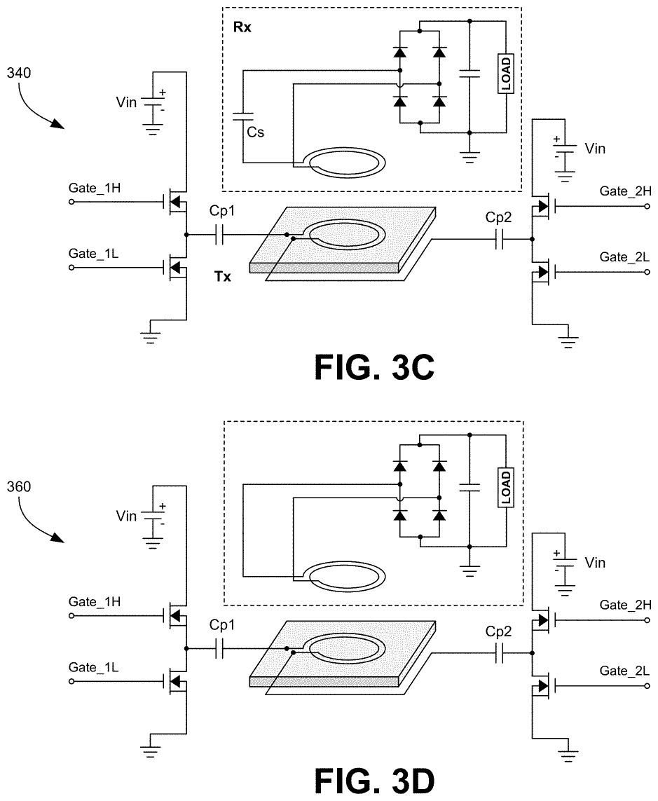

FIG. 3A illustrates a wireless power transfer system 300 as is implemented in the art. FIG. 3B illustrates an implementation of a wireless power transfer system 320 according to the embodiment of the present disclosure as illustrated in FIGS. 1B, without a secondary resonant capacitor Cs as shown in FIG. 3A. In FIGS. 3A and 3B, a single primary coil is used in both the transmitter Tx and the receiver Rx, and a single primary capacitor Cp is directly connected between the primary coil and a half-bridge rectifier. FIG. 3C illustrates a wireless power transfer system 340 as is implemented in the art. FIG. 3D illustrates an implementation of a wireless power transfer system 360 according to the embodiment of the present disclosure as illustrated in FIG. 1B, without a secondary resonant capacitor Cs as shown in FIG. 3C. In FIGS. 3C and 3D, a single primary coil is used in both the transmitter Tx and the receiver Rx, and two primary capacitors Cp1, Cp2 are directly connected to the primary coil with each of the primary capacitors Cp1, Cp2 being connected to a half-bridge rectifier. In FIGS. 3B and 3D, no resonant secondary capacitor Cs is connected to the receiver Rx.

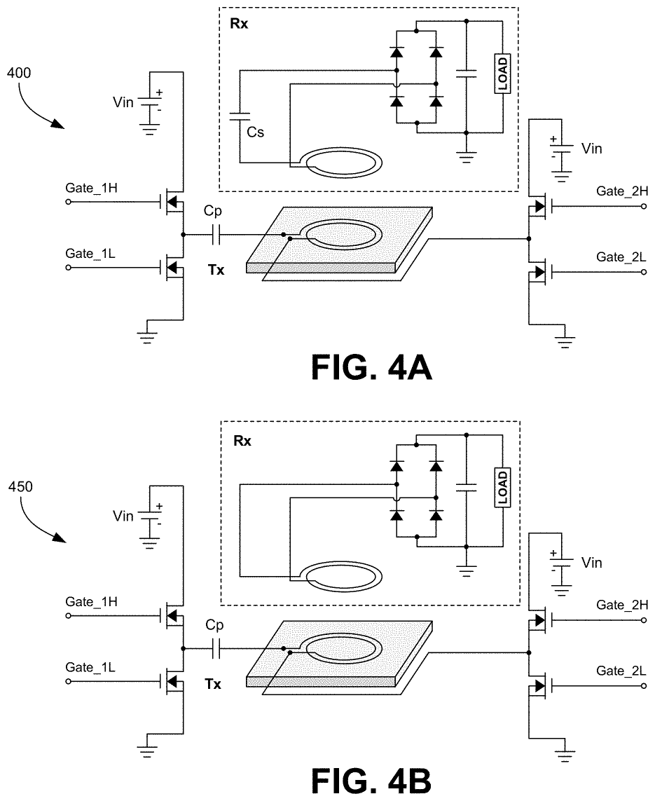

FIG. 4A illustrates a wireless power transfer system 400 as is implemented in the art. FIG. 4B illustrates an implementation of a wireless power transfer system 450 according to the embodiment of the present disclosure as illustrated in FIG. 1B, without a secondary resonant capacitor Cs as shown in FIG. 4A. FIG. 4A is similar to FIG. 3C, and FIG. 4B is similar to FIG. 3D, with the exception of only a single primary capacitor Cp is used, directly connected between the primary coil and one of the half-bridge rectifiers. The other half-bridge rectifier is connected directly to the primary coil Cp of the transmitter Tx.

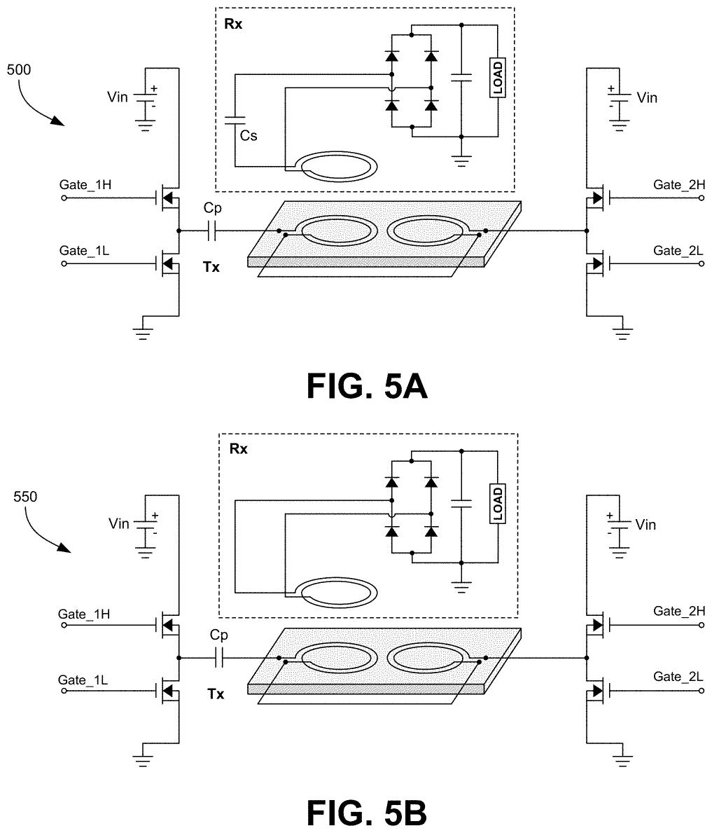

FIG. 5A illustrates a wireless power transfer system 500 as is implemented in the art. FIG. 5B illustrates an implementation of a wireless power transfer system 550 according to the embodiment of the present disclosure as illustrated in FIG. 1B, without a secondary resonant capacitor Cs as shown in FIG. 5A. FIG. 5A is similar to FIG. 4A, and FIG. 5B is similar to FIG. 4B, with the exception that the transmitter Tx comprises two coils connected in series. Here a primary capacitor Cp is connected between a first coil of the transmitter Tx and a half-bridge rectifier, while the second coil of the transistor Tx is directly connected to the other half-bridge rectifier.

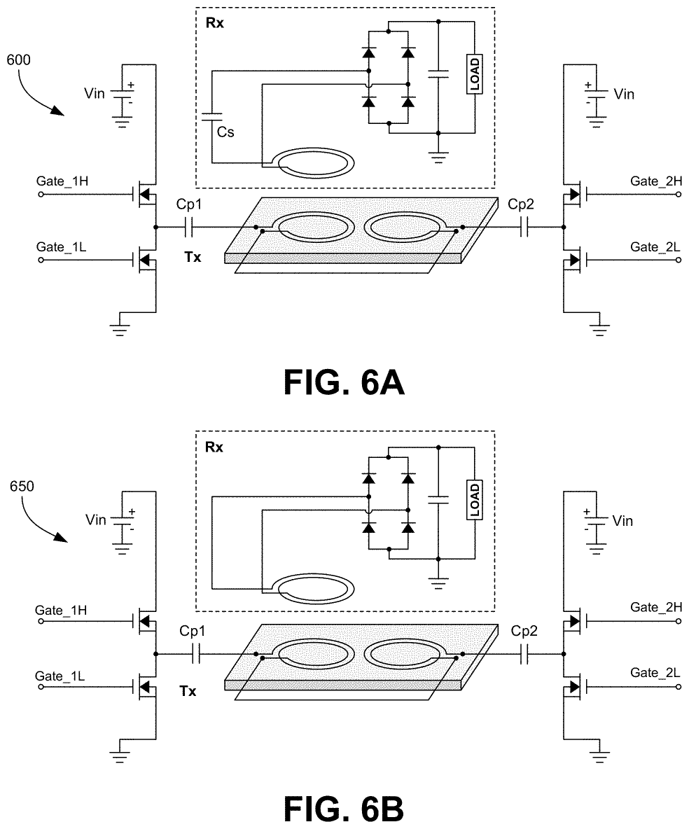

FIG. 6A illustrates a wireless power transfer system 600 as is implemented in the art. FIG. 6B illustrates an implementation of a wireless power transfer system 650 according to the embodiment of the present disclosure as illustrated in FIG. 1B, without a secondary resonant capacitor Cs as shown in FIG. 6A. FIG. 6A is similar to FIG. 5A, and FIG. 6B is similar to FIG. 5B, with the exception that each of the two transmitter coils is connected to a half-bridge rectifier via a primary capacitor Cp1, Cp2.

It should be noted that the term “directly connected to” indicates that the components are connected to each other without anything else connected between the components. It should also be noted that the term “about” or “approximately” indicates a range of ±20% of the stated value. Further, all the necessary electronic components of the transmitter circuit Tx and the receiver circuit Rx may not be described in the foregoing for brevity, however such electronic components are within the scope of the person of ordinary skill in the art and are hereby included in this disclosure.

Other objects, advantages and embodiments of the various aspects of the present invention will be apparent to those who are skilled in the field of the invention and are within the scope of the description and the accompanying Figures. For example, but without limitation, structural or functional elements might be rearranged consistent with the present invention. Similarly, principles according to the present invention could be applied to other examples, which, even if not specifically described here in detail, would nevertheless be within the scope of the present invention.

1. A wireless power transfer system comprising:
a wireless power receiver comprising a receiver coil configured to couple with a magnetic field emitted by a wireless power transmitter,
wherein
a time-varying current is induced in the receiver coil by the magnetic field, and
the wireless power receiver does not comprise a resonant capacitor.

2. The wireless power transfer system of claim 1, wherein a frequency response of the wireless power transfer system comprises a single significant peak.

3. The wireless power transfer system of claim 1, wherein the receiver coil comprises any combination of single spiral coils, multiple spiral coils, longitudinal coils, or coils having any polarity structure.

4. The wireless power transfer system of claim 2, wherein the wireless power receiver may further comprise at least one auxiliary non-resonant capacitor.

5. The wireless power transfer system of claim 4, wherein the auxiliary capacitor does not contribute to or affect an existing resonant frequency of the wireless power transfer system.

6. The wireless power transfer system of claim 4, wherein the auxiliary capacitor does not create another peak in the frequency response of the wireless power system.

7. The wireless power transfer system of claim 4, wherein the auxiliary capacitor is greater than about 470 nF.

8. The wireless power transfer system of claim 1, wherein a single significant resonant frequency of the system is configured to be less than about 400 kHz.

9. A wireless power transfer system comprising:
a wireless power transmitter comprising a transmitter coil configured to receive a time-varying current that flows in the transmitter coil to produce a transmitter magnetic field;
a wireless power receiver comprising a receiver coil; and
a resonant capacitor, wherein
the transmitter magnetic field is configured to couple the wireless power transmitter with the wireless power receiver to induce a time-varying current to flow in the receiver coil of the wireless power receiver, and
the resonant capacitor is coupled to the wireless power transmitter and not the wireless power receiver.

10. The wireless power transfer system of claim 9, wherein the resonant capacitor is configured to set a resonant frequency of the wireless power transmitter when the wireless power receiver is unloaded.

11. The wireless power transfer system of claim 9, wherein the resonant capacitor is physically located in the wireless power transmitter and not the wireless power receiver.

12. The wireless power transfer system of claim 9, wherein a frequency response of the wireless power transfer system comprises a single significant peak.

13. The wireless power transfer system of claim 12, wherein the wireless power transmitter and/or the wireless power receiver may further comprise at least one auxiliary non-resonant capacitor.

14. The wireless power transfer system of claim 13, wherein the auxiliary capacitor does not contribute to or affect an existing resonant frequency of the wireless power transfer system.

15. The wireless power transfer system of claim 13, wherein the auxiliary capacitor does not create another peak in the frequency response of the wireless power system.

16. The wireless power transfer system of claim 14, wherein the auxiliary capacitor is greater than 470 nF.

17. The wireless power transfer system of claim 9, wherein the transmitter and receiver coils comprise any combination of single spiral coils, multiple spiral coils, longitudinal coils, or coils having any polarity structure.

18. The wireless power transfer system of claim 9, wherein a single significant resonant frequency of the system is configured to be less than about 400 kHz.

19. A wireless power transfer system comprising:
a wireless power transmitter comprising a transmitter coil configured to receive a time-varying current that flows in the transmitter coil to produce a transmitter magnetic field;
a wireless power receiver comprising a receiver coil; and
a resonant capacitor, wherein
the transmitter magnetic field is configured to couple the wireless power transmitter with the wireless power receiver to induce a time-varying current to flow in the receiver coil of the wireless power receiver, and
the resonant capacitor is only coupled to either the wireless power transmitter or the wireless power receiver, but not both.

20. The wireless power transfer system of claim 19, wherein the resonant capacitor is only coupled to the wireless power transmitter and not the wireless power receiver.

21. The wireless power transfer system of claim 19, wherein the resonant capacitor is only coupled to the wireless power receiver and not the wireless power transmitter.

22. The wireless power transfer system of claim 19, wherein the resonant capacitor is configured to set a resonant frequency of the wireless power transmitter when the resonant capacitor is only coupled to the wireless power transmitter and the wireless power receiver is unloaded.

23. The wireless power transfer system of claim 19, wherein the resonant capacitor is configured to set a resonant frequency of the wireless power receiver when the resonant capacitor is only coupled to the wireless power receiver and the wireless power receiver is unloaded.

24. The wireless power transfer system of claim 19, wherein the resonant capacitor is physically located in the wireless power transmitter and not the wireless power receiver.

25. The wireless power transfer system of claim 19, wherein the resonant capacitor is physically located in the wireless power receiver and not the wireless power transmitter.

26. The wireless power transfer system of claim 19, wherein a frequency response of the wireless power transfer system comprises a single significant peak.

27. The wireless power transfer system of claim 26, wherein the wireless power transmitter and/or the wireless power receiver may further comprise at least one auxiliary non-resonant capacitor.

28. The wireless power transfer system of claim 27, wherein the auxiliary capacitor does not contribute to or affect an existing resonant frequency of the wireless power transfer system.

29. The wireless power transfer system of claim 27, wherein the auxiliary capacitor does not create another peak in the frequency response of the wireless power system.

30. The wireless power transfer system of claim 28, wherein the auxiliary capacitor is greater than 470 nF.

31. The wireless power transfer system of claim 19, the transmitter and receiver coils comprise any combination of single spiral coils, multiple spiral coils, longitudinal coils, or coils having any polarity structure.

32. The wireless power transfer system of claim 19, wherein a single significant resonant frequency of the system is configured to be less than about 400 kHz.

33. The wireless power transfer system of claim 19, wherein a single significant resonant frequency of the system is configured to be between about 80 kHz and about 100 kHz.

34. The wireless power transfer system of claim 19, wherein a single significant resonant frequency of the system is configured to be about 85 kHz.
